(19) United States
(12) Patent Application Publication
(10) Pub. No.: US 2004/0177547 A1
(43) Pub. Date: Sep. 16, 2004

(54) Fuel emulsions and methods of manufacture

(76) Inventors: Steven Donald Anderson, Naperville, IL (US); John C. Thurston, Naperville, IL (US)

Correspondence Address: BP America Inc., Docket Clerk, BP Legal, M.C. 5 East, 4101 Winfield Road, Warrenville, IL, 60555, US

(21) Appl. No.: 10/389,336

(22) Filed: Mar. 14, 2003

(51) Int. Cl. B01D 3/34

(52) U.S. Cl. 44/302

(57) ABSTRACT

A method of producing a water-fuel emulsion is disclosed. The method includes the steps of recovering a contaminated water component, the water component comprising water contaminated with one or more selected from the group consisting of a contaminant fuel, oil or glycol, and mixing one or more fuel components and the contaminated water component to produce a water-fuel emulsion. Typical contaminant fuels include aviation fuels, gasolines, diesel fuels, distillates and fuel oils. Water-fuel emulsion compositions are also disclosed. Typical fuel components include middle distillates and fuel oils.

### FIELD OF THE INVENTION

The present invention relates in general to a water-fuel emulsion comprising contaminated water, and to uses of said emulsion. More specifically the invention relates to the manufacture and use of water-fuel emulsions produced from contaminant-containing water streams, with the emulsions being useful directly as fuels, or as fuel components.

### BACKGROUND OF THE INVENTION

Water may become contaminated with a contaminant fuel or other contaminants in a number of ways. For example, one of the most significant sources of fuel-contaminated water is water obtained from dewatering of hydrant pit boxes and valve chambers at fuel installations, such as fuel depots. Another source is run-off or ground water around such fuel installations. Fuel-contaminated water may also be found around refineries and other large-scale industrial installations.

Such contaminated water can present an environmental burden, and generally either needs to be suitably treated to meet acceptable environmental standards before it can be returned it to the environment or disposed of. This may present a considerable cost. It is therefore desired to find a way to reduce the environmental burden of such contaminated water.

### SUMMARY OF THE INVENTION

Surprisingly, it has now been found that contaminated water may be combined with one or more fuel components to form a water-fuel emulsion suitable for use as a fuel or fuel component.

Thus, the present invention provides a method of producing a water-fuel emulsion comprising the steps of:

(i) recovering a contaminated water component, the water component comprising water contaminated with one or more selected from the group consisting of a contaminant fuel, oil and glycol, and

(ii) mixing one or more fuel components and the contaminated water component to produce a water-fuel emulsion.

The present invention also provides a water-fuel emulsion, wherein said emulsion is produced by mixing (a) a recovered contaminated water component, the water component comprising water contaminated with one or more selected from the group consisting of a contaminant fuel, oil and glycol, with (b) one or more fuel components.

The use of contaminated water to produce water-fuel emulsions can provide advantages over the known methods of treatment or disposal of the contaminated water. In particular, use of the contaminated water as a component of a water-fuel emulsion, means that costs of treating or disposing of the contaminated water can be reduced. In one embodiment, the water-fuel emulsions according to the present invention can be produced and utilised in the vicinity of the source of the contaminated water. For example, for a contaminated water source at an airport, the water-fuel emulsion produced from the contaminated water may be used as an emulsion fuel in airport stationary power sources and ground vehicles.

In another embodiment, the emulsion fuels are combusted and can also have reduced emissions compared to combustion of non-emulsion fuels.

### DETAILED DESCRIPTION OF THE INVENTION

The present invention is of particular utility where significant amounts of water contaminated with one or more selected from the group consisting of a contaminant fuel, oil and glycol (“contaminated water”) may be produced. For example, significant amounts of fuel-contaminated water may be produced at fuel depots, and, especially, at airports or marine terminals, where large amounts of fuel may be stored. One source of such contaminated water, for example, is water drained from storage tanks and filter vessels. However, the present invention may also be of use at other fuel storage depots, at refineries, in chemical plants, or at oil and fuel pipeline hubs.

The present invention can thus provide an alternative method of use/disposal of the contaminated water, and can reduce the costs associated with contaminated water disposal.

The one or more fuel components preferably comprise one or more middle distillate fuel components, such as diesel, kerosene and gas oil, and fuel oil components.

In one embodiment, the contaminated water component comprises water contaminated with one or more contaminant fuels. Typical contaminant fuels include aviation fuels, gasolines, diesel fuels, distillates, fuel oils and mixtures thereof.

As used in this application, “aviation fuel” includes any fuel manufactured for aviation use, and includes both aviation gasolines (avgas) and aviation jet fuels (aviation turbine fuel). Aviation gasolines include but are not limited to high octane aviation gasoline for use in piston engine aircraft. Such fuels preferably meet the ASTM D 910 standard for aviation gasolines. Aviation jet fuels include, but are not limited to, kerosene grade fuels intended for use in civil or military jet aircraft. Fuels for use in civil aircraft should meet ASTM specification D 1655-02, and include, for example, Jet A and Jet A-1. Fuels for use in military aircraft include, for example, JP-8.

Diesel fuel, as used in this application, includes any fuel manufactured for use in diesel engines, such as Diesel Engine Road Vehicle (DERV) fuel. Such fuels preferably meet the ASTM specification D 975-02.

Gasoline, as used in this application, includes any fuel manufactured for use in gasoline engines, such as car and motorcycle engines. Such fuels preferably meet the ASTM specification D 4814-01a.

In one embodiment, the contaminant fuel may comprise a marine fuel, such as a fuel oil. Marine fuel-contaminated water may be derived, for example, from around marine fuel storage tanks at ports or dockyards.

As used in this application, “marine fuel” includes any fuel manufactured for marine use, and includes both distillate marine fuels, such as marine diesel fuels, and residual fuels, such as fuel oils, for example No. 6 Fuel Oil. Such fuels preferably meet the ASTM specification D 2069-91(1998) for marine fuels.

Hence the present invention also provides a method of producing a water-fuel emulsion comprising the steps of:

(i) recovering a contaminated water component, the water component comprising water contaminated with marine fuel, and

(ii) mixing one or more fuel components and the contaminated water component to produce a water-fuel emulsion.

The present invention also provides a water-fuel emulsion, wherein said emulsion is produced by mixing (a) a recovered contaminated water component, comprising water contaminated with marine fuel and (b) one or more fuel components selected from the group consisting of middle distillate fuel components and fuel oil components.

In a further example, the contaminant fuel may comprise hydrocarbon fuel components from a refinery.

Preferably, the contaminant fuel comprises aviation fuel, preferably aviation jet fuel such as Jet-A or Jet A-1. Such aviation fuel-contaminated water may be derived from around and within aviation fuel storage tanks or fuelling locations at airports.

Where the contaminant fuel comprises aviation fuel, the one or more fuel components most preferably comprises one or more middle distillate fuel components, such as selected from the group consisting of diesel, kerosene and gas oil.

Hence, preferably, the present invention also provides a method of producing a water-middle distillate fuel emulsion comprising the steps of:

(i) recovering a contaminated water component, the water component comprising water contaminated with aviation fuel, and

(ii) mixing one or more middle distillate fuel components and the contaminated water component to produce a water-middle distillate fuel emulsion.

The present invention also preferably provides a water-middle distillate fuel emulsion, wherein said emulsion is produced by mixing (a) a recovered contaminated water component, comprising water contaminated with aviation fuel and (b) one or more middle distillate fuel components.

In another embodiment, the contaminated water component comprises water contaminated with oil, for example crude oil. Such oil-contaminated water may be derived from around crude oil pipelines, especially pipeline hubs, or from on or around drilling and pumping stations.

In another embodiment, the contaminated water component comprises water contaminated with one or more glycols. Typical glycols are those commonly used as aircraft and runway de-icers, such as at airports.

The method of the present invention comprises the step of recovery of a contaminated water component. Recovery may be performed, for example, by a suitable method of collection of the contaminated water component. In one embodiment, contaminated water is recovered by collecting the contaminated water obtained from dewatering of hydrant pit boxes and/or valve chambers. In another embodiment, contaminated water is recovered by collecting run-off or ground water around fuel installations, for example, in a suitable tank. The recovered contaminated water component may, if required, be filtered, for example, to remove particulate matter, prior to mixing with the one or more fuel components.

The contaminated water component used in the water-fuel emulsion may be derived from one source of contaminated water, or may be derived from more than one source of contaminated water. As one example, where the contaminant is a contaminant fuel, then fuel-contaminated water from one or more sources may be combined with non-fuel contaminated water, such as fresh, distilled or tap water or water contaminated with non-fuel contaminants, such as glycol-contaminated water. In particular, water contaminated with aviation fuel and water contaminated with one or more glycols may both be found at an airport, and it may be beneficial to combine both contaminated waters in the contaminated water component of the water-fuel emulsion.

Alternatively, all the contaminated water used may be fuel-contaminated water. Where such water is derived from more than one source then the contaminated waters from different sources may be contaminated with the same type of contaminant fuel, e.g. aviation fuel, or with different contaminant fuels, e.g. one type of contaminated water may be contaminated with aviation fuel and one with diesel fuel.

The contaminated water component may comprise any level of contamination. Preferably, the contamination level may be as low as 100 ppm by weight or less. Preferably, the contamination level may be as high as 1% by weight or higher, for example 5%. Contaminated water with a relatively low level of contaminant may be used with contaminated water with a relatively high level of contaminant to produce a contaminated water component with the appropriate level of contamination, if required.

The level of the contaminant (contaminant fuel, oil and/or glycol) in the fuel-water emulsion will depend on the level of contaminant in the contaminated water component, and the amount of contaminated water used in the emulsion. The level of the contaminant in the water-fuel emulsion is preferably less than 5% of the total weight, and most preferably less than 1% of the total weight.

The water-fuel emulsions according to the present invention may be produced by any known method, such as, for example the methods described in WO 99/54426, WO02/46335, EP 0156486 and EP 0162591, the disclosures of which are hereby incorporated by reference. The water-fuel emulsions according to the present invention will comprise both a fuel phase and an aqueous (water) phase. One phase (the dispersed phase) will be dispersed in the form of droplets in the other phase (the continuous phase). The water-fuel emulsions may be either so-called fuel-continuous (water in fuel) emulsions or water-continuous (fuel in water) emulsions.

In general, emulsions may be produced by subjecting a mixture of the required components to a shearing force for sufficient time to form the emulsion. WO 99/54426, for example, describes production of emulsions by heating the various components, mixing and then shearing the mixture using a preferred shear pressure of 100 to 200 psi. EP 0156486 and EP 0162591 relate to the preparation of oil in water and bitumen in water emulsions respectively. These emulsions are preferably prepared by mixing under low shear conditions in the range 10 to 1000 s⁻¹.

The fuel-continuous emulsions preferably comprise up to 25% by weight water phase, such as 5 to 25% by weight, most preferably 10 to 20% by weight.

These emulsions preferably comprise a minimum of 75% by weight of fuel phase, such as 75 to 95% by weight, most preferably 80 to 90% by weight.

Where the water-fuel emulsion is a fuel continuous emulsion, the one or more fuel components preferably comprise one or more middle distillate fuel components, such as diesel, kerosene, gas oil or mixtures thereof, and most preferably the one or more middle distillate fuel components is a diesel fuel.

The water-continuous emulsions preferably comprise up to 60% by weight water phase, such as 25 to 60% by weight, most preferably 30 to 40% by weight.

These emulsions preferably comprise a minimum of 40% by weight of fuel phase, such as 40 to 75% by weight, most preferably 60 to 70% by weight.

If the fuel content is too low then the calorific value of the fuel may be too low.

Where the water-fuel emulsion is a water continuous emulsion, the one or more fuel components preferably comprise one or more fuel oil components.

The water-fuel emulsions according to the present invention preferably also comprise one or more additives known to stabilise such emulsions, preferably one or more surfactants. Suitable surfactants are known to those working in the art, and include non-ionic surfactants, anionic surfactants and cationic surfactants.

Suitable non-ionic surfactants include ethoxylated alkyl phenols, ethoxylated alcohols and ethoxylated sorbitan esters.

Suitable anionic surfactants include the salts of long (e.g. hydrocarbon) chain carboxylic and sulphonic acids, and long (e.g. hydrocarbon) chain sulphates.

Suitable cationic surfactants include the hydrochlorides of fatty diamines, imidazoles, ethoxylated amines, amido-amides and quaternary ammonium compounds.

When a surfactant is employed, it may be present in an amount of 0.1 to 5 wt % based on the total weight of the water-fuel emulsion.

In particular, the fuel-continuous emulsions according to the present invention preferably comprise one or more emulsifying surfactant additives comprising one or more of sorbitan esters, alkylphenols possessing low degrees of ethoxylation (preferably less than 6 ethylene oxide units per alkylphenol group), and amine derivatives of polyisobutylene succinic anhydride. Preferably, the fuel-continuous emulsions may comprise up to 3% by weight of surfactant additive, more preferably 1 to 2% by weight.

Where the one or more fuel components is a diesel fuel, the diesel continuous water-diesel emulsion may be produced by a suitable emulsion technology, such as PuriNOx (Trademark) Technology, as available from The Lubrizol Corporation of Wickliffe, Ohio. This technology, for example, involves blending, in a blending unit, the water and fuel components with Lubrizol's PuriNOx fuel additive chemistry, to produce the water-in-diesel emulsion.

The water-fuel emulsions of the present invention may also independently comprise one or more conventional fuel additives as known to one skilled in the art. Suitable additives may include ignition improvers, combustion improvers, corrosion inhibiters, biocides, SOx reducing agents, NOx reducing agents, ash modifiers and soot release agents.

The water-continuous emulsions of the present invention may comprise compatible water-soluble additives. Said water-soluble additives, when present, can advantageously dissolve in the continuous water phase surrounding the fuel phase droplets of the emulsion. These additives, when present, may have been added to the prepared emulsion, or may have been added to the water phase prior to emulsification.

In addition, low temperature stability, antifreeze agents, such as alcohols, for example, methanol and ethanol, or glycols, for example, ethylene glycol, may also be present, if required.

In certain embodiments one or more low sulphur fuels, for example one or more low sulphur diesel fuels, are used as the one or more fuel components, especially if the contaminated water component comprises relatively high sulphur levels, for example due to high sulphur levels in a contaminant fuel.

Low sulphur diesel fuels, as used herein, refers to diesel fuels comprising less than 100 ppm sulphur. Preferably the diesel fuels comprise less than 50 ppm sulphur, and most preferably less than 10 ppm sulphur.

The water-fuel emulsions of the present invention may also comprise insoluble contaminants. Preferably, the level of such contaminants in the water-fuel emulsions may be relatively low, for example, less than 20 ppm by weight, preferably, below 1 ppm based on the total weight of the emulsion. If the level of such contaminants in the water-fuel emulsion, or in the contaminated water component or the contaminated water prior to use to produce the water-fuel emulsion, is too high then the emulsion or water may be pre-treated, for example, by filtration, prior to use.

In certain embodiments, treatment to remove ash-forming inorganic species may also be performed, for example, by ion-exchange or by treatment to precipitate insoluble salts.

Preferably, at least a proportion of the water-fuel emulsion according to the present invention is used or loaded for use in the vicinity of the source of the contaminated water component of the emulsion. Thus significant transportation of the contaminated water component or the water-fuel emulsion can be avoided.

In a preferred embodiment of the present invention the water-fuel emulsions according to the invention may be used as emulsion fuels in suitable power units.

Hence the present invention also provides a method of fuelling a power unit, which method comprises providing a water-fuel emulsion according to the present invention to the power unit.

For example, water-middle distillate fuel emulsions, especially water-diesel fuel emulsions, may be used as emulsion fuels in suitable diesel powered power units, such as diesel engines.

Preferably, at least a proportion of the water-fuel emulsion produced is used as a fuel in a power unit in the vicinity of the source of the contaminated water component of the emulsion.

For example, for a contaminated water source at an airport, such as a source of water contaminated with aviation fuel and/or a source of water contaminated with glycol, at least a proportion of the contaminated water is preferably used to produce a water-middle distillate fuel emulsion for use as a fuel at the airport itself, such as, as a fuel-continuous water-diesel fuel emulsion for suitable power units at the airport.

Suitable power units at an airport may include mobile power units, such as engines on airport ground vehicles, and stationary power units. By airport ground vehicles is meant any vehicle which is normally permanently resident at the airport, i.e. does not or is not licensed to leave the airport under normal operation. Such vehicles include, for example, airport service vehicles such as refuelling vehicles, catering vehicles, shuttle buses and luggage-handling vehicles.

Preferably, the emulsion for the foregoing use is a fuel-continuous water-diesel emulsion comprising 10 to 20% by weight water phase and 80 to 90% by weight diesel phase.

As further examples, a fuel-continuous water-diesel emulsion produced from contaminated water obtained from a source at a dockyard, such as a source of water contaminated with marine fuel, may be used as a water-diesel fuel emulsion in suitable power units at the dockyard (“dockyard-based power units”), and a water continuous water-fuel oil emulsion produced from contaminated water obtained at a dockyard may be used as a fuel in marine heavy fuel diesel engines, and may be loaded for use at the dockyard. By dockyard-based power units is meant any suitable vehicle or stationary power unit commonly used in the vicinity of docks, such as, for example, forklifts and cranes. In this example, both fuel-continuous and water-continuous emulsions may be derived from the same source of contaminated water. Hence, a source of water contaminated with marine fuel at a dockyard, may be used to produce either or both of a fuel-continuous water-middle distillate fuel emulsion for use with ground vehicles or stationary power units at the dockyard, and a water-continuous water-fuel oil emulsion for use in heavy fuel diesel engines.

Preferably the fuel-continuous water-diesel emulsion comprises 10 to 20% by weight water phase and 80 to 90% by weight diesel phase.

Preferably the water-continuous water-fuel oil emulsion comprises 30 to 40% by weight water phase and 60 to 70% by weight fuel oil phase.

A process of fuelling a marine vessel with emulsion fuels (prepared from non-contaminated water) is described, for example, in WO02/46335, the disclosure of which is hereby incorporated by reference.

Hence the present invention provides a method of fuelling a power unit, which method comprises providing a water-middle distillate fuel emulsion, said emulsion comprising a water component contaminated with a contaminant selected from aviation fuel and marine fuel, to the power unit. More preferably the water-middle distillate fuel emulsion is a fuel-continuous water-diesel fuel emulsion as described previously.

The present invention also provides a method of fuelling a marine heavy fuel diesel engine, which method comprises providing a water-continuous water-fuel oil emulsion to the marine heavy fuel diesel engine.

As well as use as fuels, water-fuel emulsions may be used to aid transportation of hydrocarbons. Hence in another embodiment the water-fuel emulsion of the present invention is used to aid hydrocarbon transport mechanisms, such as through pipelines. For example, a water-fuel emulsion produced from contaminated water obtained at a hydrocarbon pipeline hub may be added to the hydrocarbon to aid transportation.

The water-fuel emulsions according to the present invention, when used as fuels, may also have significant emissions benefits over the use of “pure” fuels in certain applications. For example, although fuel continuous water-diesel emulsions may have a lower energy content per unit volume than diesel fuel alone (due, at least in part, to the lower diesel content) the addition of a contaminated water component to a diesel component to form a water-diesel emulsion can have significant environmental advantages, such as reducing the NOx emissions and particulate emissions. This can be particularly useful in areas of high diesel fuel use, such as in at airports with a large number of ground vehicles.

### EXAMPLE

The following is provided as an illustrative, although not limiting, example of the present invention.

Marine Emulsion Fuel

Separate water-fuel emulsions are prepared from a contaminated water component comprising <1% hydrocarbon (contaminant fuel), by mixing each respectively with one of two uncut vacuum residue feedstocks from BP's Coryton and Grangemouth refineries in the UK (fuel components), and based on the “High Internal Phase Ratio (HIPR)” preparation method described in EP-A-0156486 and EP-A-0162591.

Specifically, each uncut vacuum residue feedstock is heated to 70° C., and 5 parts by weight of each residue are added to one part by weight of a surfactant solution comprising 2 wt % Igepal CA-630 (octylphenol 9-ethoxylate) in deionised water, originally at ambient temperature. The components are then mixed using a hand-held low speed (1200 rpm) domestic mixer for one minute to produce an HIPR emulsion, exhibiting a smooth texture. Owing to the relative densities of the components, the use of parts by volume and parts by weight can be considered to be interchangeable. After the initial mixing stage, quantities of the contaminated water component are added to produce water-fuel emulsions with 65% by weight residue, stabilized by approximately 0.25 wt % surfactant.

The water-fuel emulsions thus produced may be used as marine emulsion fuels.

While certain embodiments of the invention have been described in detail, other embodiments of the invention will be apparent to those or ordinary skill in the art after reviewing the specification, and the invention is intended to be limited only by the scope of the following claims.

We claim:

1. A method of producing a water-fuel emulsion comprising the steps of:
(i) recovering a contaminated water component, the water component comprising water contaminated with one or more selected from the group consisting of a contaminant fuel, oil and glycol, and
(ii) mixing one or more fuel components and the contaminated water component to produce a water-fuel emulsion.

2. A method for fuelling a vehicle or stationary power source comprising
(i) providing a water-fuel emulsion produced according to the method of claim 1, and
(ii) fuelling a vehicle or stationary power source with said emulsion.

3. The method of claim 2 further comprising the step of combusting the emulsion in said vehicle or stationary power source.

4. The method of claim 1, which method further comprises mixing, with the contaminated water component and the one or more fuel components, one or more surfactants selected from the group consisting of non-ionic surfactants, anionic surfactants and cationic surfactants.

5. The method of claim 1, wherein the one or more fuel components is selected from the group consisting of middle distillate fuel components and fuel oil components.

6. The method of claim 5, wherein the one or more fuel components is a diesel fuel.

7. The method of claim 1, wherein the contaminated water component is contaminated with an aviation jet fuel selected from the group consisting of Jet-A and Jet A-1.

8. A method of producing a water-middle distillate fuel emulsion comprising the steps of:
(i) recovering a contaminated water component, the water component comprising water contaminated with aviation fuel, and
(ii) mixing one or more middle distillate fuel components and the contaminated water component to produce a water-middle distillate fuel emulsion.

9. The method of claim 8, which method further comprises combining, with the contaminated water component and the one or more middle distillate fuel components, one or more surfactants selected from the group consisting of non-ionic surfactants, anionic surfactants and cationic surfactants.

10. The method of claim 8, wherein the aviation fuel is selected from the group consisting of Jet-A and Jet A-1.

11. The method of claim 8, wherein the water-middle distillate fuel emulsion is a fuel-continuous emulsion, and comprises up to 25% by weight water phase, and a minimum of 75% by weight of fuel phase.

12. The method of claim 9, wherein the water-middle distillate fuel emulsion comprises 0.1 to 5 wt % surfactant, based on the total weight of the water-middle distillate fuel emulsion.

13. The method of claim 11, which method further comprises combining, with the contaminated water component and the one or more middle distillate fuel components, up to 3% by weight of one or more emulsifying surfactant additives selected from the group consisting of sorbitan esters, alkylphenols ethoxylated with less than 6 ethylene oxide units per alkylphenol group, and amine derivatives of polyisobutylene succinic anhydride.

14. The method of claim 8, which method further comprises combining, with the contaminated water component and the one or more middle distillate fuel components, one or more fuel additives.

15. The method of claim 14, wherein the one or more fuel additives is selected from the group consisting of ignition improvers, combustion improvers, corrosion inhibiters, biocides, SOₓ reducing agents, NOₓ reducing agents, ash modifiers and soot release agents.

16. The method of claim 8, which method further comprises combining, with the contaminated water component and the one or more middle distillate fuel components, one or more low temperature stability, antifreeze agents.

17. The method of claim 16, wherein the one or more low temperature stability, antifreeze agents are selected from the group consisting of alcohols and glycols.

18. The method of claim 17, wherein the one or more low temperature stability, antifreeze agents are selected from the group consisting methanol, ethanol and ethylene glycol.

19. The method of claim 8, wherein the one or more middle distillate fuel components is a diesel fuel.

20. The method of claim 19, wherein the diesel fuel is a low sulphur diesel fuel.

21. A method of fuelling a power unit at an airport, which method comprises providing a water-middle distillate fuel emulsion, as produced according to the method of claim 8, to the power unit.

22. The method of claim 21, wherein the water-middle distillate fuel emulsion is a diesel continuous water-diesel fuel emulsion and is provided to an airport ground vehicle.

23. The method of claim 21, wherein the water-middle distillate fuel emulsion is a diesel continuous water-diesel emulsion and is provided to a stationary power unit at an airport.

24. The method of claim 21, wherein the water-middle distillate fuel emulsion further comprises one or more surfactants selected from the group consisting of non-ionic surfactants, anionic surfactants and cationic surfactants.

25. A method of producing a water-fuel emulsion comprising the steps of:
(i) recovering a contaminated water component, the water component comprising water contaminated with marine fuel, and
(ii) mixing one or more fuel components and the contaminated water component to produce a water-fuel emulsion.

26. The method of claim 25, which method further comprises combining, with the contaminated water component and the one or more fuel components, one or more surfactants selected from the group consisting of non-ionic surfactants, anionic surfactants and cationic surfactants.

27. The method of claim 25, wherein the marine fuel is a fuel oil.

28. The method of claim 25, wherein the water-fuel emulsion is a fuel-continuous water-middle distillate fuel emulsion, and comprises up to 25% by weight water phase, and a minimum of 75% by weight of fuel phase.

29. The method of claim 25, wherein the water-fuel emulsion is a water-continuous water-fuel oil emulsion, and comprises up to 60% by weight water phase, and a minimum of 40% by weight of fuel phase.

30. The method of claim 26, wherein the water-fuel emulsion comprises 0.1 to 5 wt % surfactant, based on the total weight of the water-fuel emulsion.

31. The method of claim 28, which method further comprises combining, with the contaminated water component and one or more middle distillate fuel components, up to 3% by weight of one or more emulsifying surfactant additives selected from the group consisting of sorbitan esters, alkylphenols ethoxylated with less than 6 ethylene oxide units per alkylphenol group, and amine derivatives of polyisobutylene succinic anhydride.

32. The method of claim 25, which method further comprises combining, with the contaminated water component and the one or more fuel components, one or more fuel additives.

33. The method of claim 32, wherein the one or more fuel additives is selected from the group consisting of ignition improvers, combustion improvers, corrosion inhibiters, biocides, SOₓ reducing agents, NOₓ reducing agents, ash modifiers and soot release agents.

34. The method of claim 25, which method further comprises combining, with the contaminated water component and the one or more fuel components, one or more low temperature stability, antifreeze agents.

35. The method of claim 34, wherein the one or more low temperature stability, antifreeze agents are selected from the group consisting of alcohols and glycols.

36. The method of claim 35, wherein the one or more low temperature stability, antifreeze agents are selected from the group consisting methanol, ethanol and ethylene glycol.

37. The method of claim 25, wherein the one or more fuel components is a middle distillate fuel component.

38. The method of claim 37 wherein the middle distillate fuel component is a diesel fuel.

39. The method of claim 38, wherein the diesel fuel is a low sulphur diesel fuel.

40. A method of fuelling a power unit, which method comprises providing a water-fuel emulsion, as produced according to the method of claim 25, to the power unit.

41. The method of claim 40, wherein the water-fuel emulsion is a fuel-continuous water-middle distillate fuel emulsion and is provided to a dockyard-based power unit.

42. The method of claim 41, wherein the fuel continuous water-middle distillate fuel emulsion is a fuel continuous water-diesel emulsion.

43. The method of claim 40, wherein the water-fuel emulsion is a water-continuous water-fuel oil emulsion and is provided to a marine heavy fuel diesel engine.

44. The method of claim 40, wherein the water-diesel emulsion further comprises one or more surfactants selected from the group consisting of non-ionic surfactants, anionic surfactants and cationic surfactants.

45. A water-middle distillate fuel emulsion, wherein said emulsion is produced by mixing (a) a recovered contaminated water component, comprising water contaminated with aviation fuel and (b) one or more middle distillate fuel components.

46. The water-middle distillate fuel emulsion of claim 45, which emulsion further comprises one or more surfactants selected from the group consisting of non-ionic surfactants, anionic surfactants and cationic surfactants.

47. The water-middle distillate fuel emulsion of claim 45, wherein the aviation fuel contaminant is selected from the group consisting of Jet-A and Jet A-1.

48. The water-middle distillate fuel emulsion of claim 45, which emulsion is a fuel-continuous emulsion, and comprises up to 25% by weight water phase, and a minimum of 75% by weight of fuel phase.

49. The water-middle distillate fuel emulsion of claim 46, which emulsion comprises 0.1 to 5 wt % surfactant, based on the total weight of the water-middle distillate fuel emulsion.

50. The water-middle distillate fuel emulsion of claim 48, which emulsion comprises up to 3% by weight of one or more emulsifying surfactant additives selected from the group consisting of sorbitan esters, alkylphenols ethoxylated with less than 6 ethylene oxide units per alkylphenol group, and amine derivatives of polyisobutylene succinic anhydride.

51. The water-middle distillate fuel emulsion of claim 45, which emulsion further comprises one or more fuel additives.

52. The water-middle distillate fuel emulsion of claim 51, wherein the one or more fuel additives is selected from the group consisting of ignition improvers, combustion improvers, corrosion inhibiters, biocides, SOₓ reducing agents, NOₓ reducing agents, ash modifiers and soot release agents.

53. The water-middle distillate fuel emulsion of claim 45, which emulsion further comprises one or more low temperature stability, antifreeze agents.

54. The water-middle distillate fuel emulsion of claim 53, wherein the one or more low temperature stability, antifreeze agents are selected from the group consisting of alcohols and glycols.

55. The water-middle distillate fuel emulsion of claim 54, wherein the one or more low temperature stability, antifreeze agents are selected from the group consisting methanol, ethanol and ethylene glycol.

56. The water-middle distillate fuel emulsion of claim 55, which emulsion further comprises one or more glycol components.

57. The water-middle distillate fuel emulsion of claim 45, wherein the one or more middle distillate fuel components is a diesel fuel.

58. The water-middle distillate fuel emulsion of claim 57, wherein the diesel fuel is a low sulphur diesel fuel.

59. A water-fuel emulsion, wherein said emulsion is produced by mixing (a) a recovered contaminated water component, comprising water contaminated with marine fuel and (b) one or more fuel components selected from the group consisting of middle distillate fuel components and fuel oil components.

60. The water-fuel emulsion of claim 59, which emulsion further comprises one or more surfactants selected from the group consisting of non-ionic surfactants, anionic surfactants and cationic surfactants.

61. The water-fuel emulsion of claim 59, which emulsion is a fuel-continuous water-middle distillate emulsion, and comprises up to 25% by weight water phase, and a minimum of 75% by weight of fuel phase.

62. The water-fuel emulsion of claim 59, which emulsion is a water-continuous water-fuel oil emulsion, and comprises up to 60% by weight water phase, and a minimum of 40% by weight of fuel phase.

63. The water-fuel emulsion of claim 59, which emulsion comprises 0.1 to 5 wt % surfactant, based on the total weight of the water-fuel emulsion.

64. The water-fuel emulsion of claim 61, which emulsion comprises up to 3% by weight of one or more emulsifying surfactant additives selected from the group consisting of sorbitan esters, alkylphenols ethoxylated with less than 6 ethylene oxide units per alkylphenol group, and amine derivatives of polyisobutylene succinic anhydride.

65. The water-fuel emulsion of claim 59, which emulsion further comprises one or more fuel additives.

66. The water-fuel emulsion of claim 65, wherein the one or more fuel additives is selected from the group consisting of ignition improvers, combustion improvers, corrosion inhibiters, biocides, SOₓ reducing agents, NOₓ reducing agents, ash modifiers and soot release agents.

67. The water-fuel emulsion of claim 59, which emulsion further comprises one or more low temperature stability, antifreeze agents.

68. The water-fuel emulsion of claim 67, wherein the one or more low temperature stability, antifreeze agents are selected from the group consisting of alcohols and glycols.

69. The water-fuel emulsion of claim 68, wherein the one or more low temperature stability, antifreeze agents are selected from the group consisting methanol, ethanol and ethylene glycol.
